(19) United States
(12) Patent Application Publication
(10) Pub. No.: US 2023/0185988 A1
(43) Pub. Date: Jun. 15, 2023

(54) LATENT VECTOR AR MODELING AND FEATURE ANALYSIS OF DATA WITH REDUCED DYNAMIC DIMENSIONS

(71) Applicant: City University of Hong Kong, Hong Kong (CN)

(72) Inventor: Si-Zhao QIN, Hong Kong (CN)

(21) Appl. No.: 17/644,114

(22) Filed: Dec. 14, 2021

(51) Int. Cl. G06F 30/20; G06F 17/16

(52) U.S. Cl. CPC G06F 30/20; G06F 17/16; G06F 2111/10

(57) ABSTRACT

A method for extracting latent vector autoregressive (LaVAR) models with full interactions amongst mutually independent dynamic latent variables (DLV) from multi-dimensional time series data comprising: detecting, by a plurality of sensors, dynamic samples of data corresponding to a plurality of original variables; analyzing, using a controller, the dynamic samples of data to determine a plurality of latent variables that represent variation in the dynamic samples of data; estimating an estimated current value for all of the latent variables, wherein the estimation for all of the latent values is conducted simultaneously through an iterative process; and wherein each of the latent variables are contemporaneously uncorrelated.

### FIELD

The present invention generally relates to a latent vector autoregressive (LaVAR) modeling algorithm with a canonical correlation analysis (CCA) objective to estimate a fully interacting reduced dimensional dynamic model.

### BACKGROUND

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

The present invention provides an improvement over the invention described in U.S. Pat. No. 10,955,818, the contents of which are incorporated into this specification by reference.

With the fast development of digitalization and industrial internet of things, modern dynamic systems are equipment with a large number of sensors to collect massive data for monitoring, control, and decision making. The multi-source sensors make the data high dimensional, but the actual dynamic system dimension remains unchanged. Such examples include autonomous driving vehicles and autonomously operated processes, where a high degree of sensor redundancy is employed.

Owing to safety requirements, quality control, and feedback control, the dynamic data variations are usually restricted in a reduced-dimensional latent space. Therefore, reduced-dimensional dynamic modeling has become an active research area recently in engineering, for example Q. She, Y. Gao, K. Xu, R. Chan, Reduced-rank linear dynamical systems, in: Proceedings of the AAAI Conference on Artificial Intelligence, Vol 32, 2018, pp. 4050-4057. statistics, for example in D. Pena, E. Smucler, V. J. Yohai, Forecasting multiple time series with one-sided dynamic principal components, Journal of the American Statistical Association 114 (528) (2019) 1683-1694, econometrics and financial data analytics, for example in C. Lam, Q. Yao, N. Bathia, Estimation of latent factors for high-dimensional time series, Biometrika 98 (4) (2011) 901-918 and machine learning, for example in T. Blaschke, T. Zito, L. Wiskott, Independent slow feature analysis and nonlinear blind source separation, Neutral Computation 129 (4) (2007) 994-1021.

There has been long-lasting interest in reduced dimensional modeling of dynamic data. Early works, such as in B Weare, J. Nasstrom, Examples of extended empirical orthogonal function analyses, Monthly Weather Review 110 (1982) 481-485 include method of delays (MoD), singular spectrum analysis (SSA) and multi-channel, multivariate SSA (M-SSA), and canonical analysis. In fluid dynamics, there is strong interest in data-driven modeling of highly nonlinear systems using the Koopman linear expansions and dynamic mode decomposition (DMD), which are linear projection analytics. One advantage of such methods is to compress the co-moving dynamics among the measured variables to a latent space for parsimonious dynamic modeling. Another one is to avoid the ill-conditioning problem due to data collinearity. When the latent variables possess maximized predictability or dynamics, their interpretation and visualization can be made easy owing to the reduced dimensions.

Recently, dynamic inner principal component analysis (DiPCA) and DiCCA methods have been proposed for latent dynamic modeling, based on early work in G. Li, S. J. Qin, D. Zhou. A new method of dynamic latent-variable modeling for process monitoring. IEEE Transactions on Industrial Electronics 61 (11) (2014) 6438-6445. These methods extract one dynamic latent variable (DLV) at a time to make it most predictable from its own past data. As a result, each of the DLVs is modeled as a univariate autoregressive (AR) process. These univariate AR models can be interpreted as marginal models, which are decoupled at the expense of increased variance in the innovations.

An apparent drawback of these non-interacting AR models is that they can be inefficient in extracting the DLV dynamics when the true system latent structure is interacting. The inefficiency often leads to the use of very high order AR models and an excessive number of DLVs. As an improvement, an iterative algorithm was recently developed in which employs a vector AR model for all latent variables, Y. Dong, S. J. Qin, S. Boyd, Extracting a low-dimensional predictable time series, Optimization and Engineering, doi: https://doi.org/10.1007/s11081-021-09643-x. The solution method, however, is sequential with one DLV after another. When the algorithm iterates from the (l−1)^{th} DLV to the l^{th} DLV, the weight matrix of the first (l−1) DLVs is not updated, which is sub-optimal.

The present invention proposes a novel latent vector autoregressive modeling algorithm with a canonical correlation analysis (CCA) objective. The latent dynamic models are fully interacting VAR models with a reduced dimensional latent structure to capture the most dynamic content in a multivariate time series. The LaVAR-CCA algorithm solves all DLVs simultaneously with an iterative algorithm, which has a nice interpretation of profile likelihood. The LaVAR-CCA DLVs are guaranteed to be orthogonal with a descending order of predictability, thus retaining the properties of DiCCA. In other words, the dynamic latent variables are contemporaneously uncorrelated among them. The chaotic nonlinear Lorenz oscillator is used to test the proposed algorithm where highly noisy data with redundant sensors of six dimensions are simulated. The efficacy of the proposed dynamic LaVAR algorithm in extracting the true signals is compared to principal component analysis. An industrial application to a chemical process dataset is used to illustrate the superiority of the proposed LaVAR-CCA algorithm.

### SUMMARY OF INVENTION

It is an object of this invention to ameliorate, mitigate or overcome, at least one disadvantage of the prior art, or which will at least provide the public with a practical choice.

In a first embodiment, the present invention seeks to provide a method for extracting latent vector autoregressive (LaVAR) models with full interactions amongst mutually independent dynamic latent variables (DLV) from multi-dimensional time series data comprising: detecting, by a plurality of sensors, dynamic samples of data corresponding to a plurality of original variables; analyzing, using a controller, the dynamic samples of data to determine a plurality of latent variables that represent variation in the dynamic samples of data; estimating an estimated current value for all of the latent variables, wherein the estimation for all of the latent values is conducted simultaneously through an iterative process; and wherein each of the latent variables are contemporaneously uncorrelated.

Preferably, latent variables are modelled simultaneously as a vector autoregressive model.

Preferably, the dynamic samples of data are represented in a ranked, stacked matrices.

Preferably, analyzing the dynamic samples of data includes attaching a weighting to the ranked, stacked matrices.

Preferably, autoregression is applied to a latent vector of the dynamic samples of data.

Preferably, the latent vector is represented in ranked, stacked matrices.

Preferably, a vector weighting is applied to the latent vector matrices.

Preferably, the weighting of the dynamic samples of data and the vector weighting are coupled.

Preferably, the latent vector is iteratively treated with an updated weighting.

Preferably, the treated latent vectors converge.

Preferably, the model's DLV's are orthonormal to each other.

### BRIEF DESCRIPTION OF DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 illustrates a system for extracting data according to the present invention;

FIG. 2 is a representation of the dynamic LaVAR model of the present invention vs Principal Component Analysis (PCA) and Hidden Markov Model (HMM) models;

FIG. 3 is schematic representation of data and latent score matrices of the LaVAR model of the present invention;

FIG. 4 is a graph showing the results of maximising the eigenvalues vs the number of iterations;

FIG. 5 shows the Lorenz oscillator of three dynamic variables on the LaVAR model of the present invention;

FIG. 6 shows noisy data, PCA scores and LaVAR-CCA extracted dynamic latent variable (DLV) data;

FIG. 7 illustrates 3D plots for the first three variables of the noisy data and PCA reconstructed data from FIG. 6;

FIG. 8 illustrates 3D plots for the first three variables of the noisy data and LaVAR-CCA reconstructed data from FIG. 6;

FIG. 9 illustrates the true signal contained in the noisy data and LaVAR reconstructed variable;

FIG. 10 illustrates LaVAR-CCA DLV scores;

FIG. 11 illustrates the DiCCA results from the scores of FIG. 10;

FIG. 12 illustrates the square correlation of the LaVar scores of FIG. 10 and the DiCCA results of FIG. 11;

FIG. 13 illustrates a comparison of the variance in R² values and Ljung-Box Q test values between the LaVAR-CCA and DiCCA DLV values.

In the drawings like structures are referred to by like numerals throughout the several views. The drawings shown are not necessarily to scale, with emphasis instead generally being placed upon illustrating the principles of the present invention.

### DETAILED DESCRIPTION

With reference to the figures and more broadly, the present invention will now be described.

The present invention provides a novel latent vector autoregressive modeling system, method and algorithm with a canonical correlation analysis (CCA) objective. The latent dynamic models are fully interacting VAR models with a reduced dimensional latent structure to capture the most dynamic content in a multivariate time series. The LaVAR-CCA algorithm solves all DLVs simultaneously with an iterative algorithm, which has a nice interpretation of profile likelihood. The LaVAR-CCA DLVs are guaranteed to be orthogonal with a descending order of predictability, thus retaining the properties of DiCCA. In other words, the dynamic latent variables are contemporaneously uncorrelated among them. The chaotic nonlinear Lorenz oscillator is used to test the proposed algorithm where highly noisy data with redundant sensors of six dimensions are simulated. The efficacy of the proposed dynamic LaVAR algorithm in extracting the true signals is compared to principal component analysis. An industrial application to a chemical process dataset is used to illustrate the superiority of the proposed LaVAR-CCA algorithm.

The present invention defines rigorously latent dynamic data from latent dynamic systems with a novel concept of latent dynamic dimensions. Oblique subspace projections are derived to separate dynamic latent variables from uncorrelated residuals. The differences among dynamic latent models, principal component analysis (PCA), and hidden Markov models are demonstrated. The new LaVAR algorithm with the CCA objective is developed to solve multiple DLVs simultaneously from latent dynamic data. Geometric properties and a profile likelihood interpretation of the algorithm are given. A simulated Lorenz oscillator dataset with six dimensions is presented below and demonstrates the effectiveness of the LaVAR-CCA algorithm over PCA in extracting signals from highly noisy data. An industrial chemical process dataset from Eastman Chemical is used to compare the DLV features extracted using LaVAR-CCA and DiCCA.

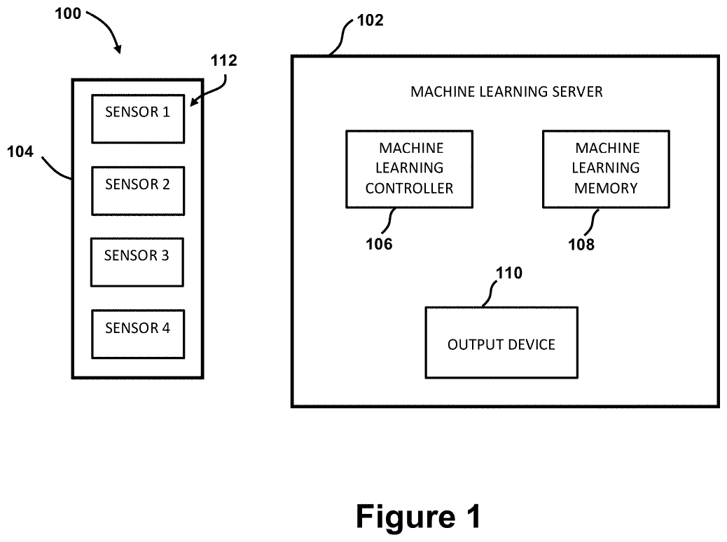

Referring to FIG. 1, a system 100 for analyzing high dimensional complex data according to the method and using the algorithm of the present invention as described below is shown. The system 100 includes a machine learning server 102 along with a data 50 source 104. The machine learning server 102 may include a machine learning controller 106, a machine learning memory 108, and an output device 110. The controller 106 performs the operations described in the methods of the present invention as described below.

Where used herein, “controller” may refer to any logic device capable of receiving one or more input and outputting one or more output. For example, a controller may include a PI controller, a processor, an application specific integrated circuit (ASIC), a digital signal processor (DSP), a field-programmable gate array (FPGA), or the like. In some embodiments, the controller 106 may be specifically designed to process relatively 60 large amounts of data.

The memory 108 may include any non-transitory memory known in the art. In that regard, the memory 108 may store data usable by the controller 106. For example, the memory 108 may store an algorithm usable by the controller 106 to 65 model the data source 104 using a set of principal time series data of dynamic latent variables.

The output device 110 may include any output device such as a display, a touchscreen, a speaker, or the like.

The data source 104 may include, for example, an industrial machine or system such as a chemical manufacturing plant, a warehouse, or the like. The data source 104 may include a plurality of sensors 112. Time series data from the plurality of sensors 112 may be transmitted to the machine learning server 102. The machine learning server 102 may make predictions regarding the data source 104 based on the data detected from the plurality of sensors 112 and based on an algorithm that uses dynamic latent variables.

### Latent Dynamic Data and Systems—Dynamic Latent Variable Models

A time series {yₖ}ₖ₌₁ with yₖ∈ [symbol] ^{p} at time k can be regarded as measured output data of a dynamic system. To facilitate subsequent exploration we give the definition of a few terminologies.

Definition 1. A time series {yₖ}ₖ₌₁^{N+s}, where yₖ∈ [symbol] ^{p}, is auto-correlated or serially correlated if

[symbol]

{yₖyₖ₋₁^{T}}≠0

for some j≠0. Otherwise, it is referred to as serially uncorrelated. Serially correlated series are also referred to as dynamic series or dynamic data due to time dependence.

Serial correlation and serial dependence are central to time series analysis, where inference of serial correlation is crucial to characterize the dynamics of time series. Analyzing serially correlated data requires time series models such as vector autoregressive (VAR) models.

For a multi-dimensional time series, it is possible that a linear combination of the variables is serially uncorrelated, even though each of the variables are serially correlated. This leads to the reduced dimensional system of time series, which is the focus of the present invention.

Definition 2. A time series {yₖ∈ [symbol] ^{p}}ₖ₌₁^{N+s} is a reduced dimensional time series of dynamic latent dimension l<p if

yₖ=Pvₖ+eₖ (1)

where vₖ∈ [symbol] ^{l} is serially correlated but no linear combination of vₖ is serially uncorrelated. P∈ [symbol] ^{p×l} has full column rank, i.e., rank(P)=l<p and eₖ∈ [symbol] ^{p} is serially independent noise.

For a reduced dimensional time series, there exist some linear combinations of the time series that are serially uncorrelated, even though each of the original variables is serially correlated. This is stated in the following lemma.

Lemma 1. For the reduced dimensional time series (1), there exists a matrix R∈ [symbol] ^{p×l} with rank(R)=l<p and R^{T}P=I such that

(I−PR^{T})yₖ=(I−PR^{T})eₖ (2)

is serially uncorrelated and

vₖ=R^{T}yₖ=vₖ+R^{T}eₖ (3)

contains the l dimensional latent dynamic series.

The proof of the lemma is straightforward. The relation (3) is clear using R^{T}P=I. The relation (2) is true since

(I−PR^{T})Pvₖ=(P−PR^{T}P)vₖ=(P−P)vₖ=0

As a byproduct of Lemma 1, substituting (3) into (1) gives

yₖ=Pvₖ+(I−PR^{T})eₖ (4)

It should be noted that both P and vₖ are part of the unknown system. For any non-singular M∈ [symbol] ^{l×l}, (1) can be transformed into

yₖ=PM⁻¹Mvₖ+eₖ=P′Mvₖ+eₖ (5)

where P′=PM⁻¹. Lemma 1 can be extended to the following theorem for a general non-singular M∈ [symbol] ^{l×l},
Theorem 1. For the reduced dimensional time series (1) of dynamic latent dimension l<p, there exists a full column rank matrix ∈ [symbol] ^{p×l} with R^{T}P′=I, where P′=PM⁻¹ for any non-singular M, such that

(I−PM⁻¹R^{T})yₖ=(I−PM⁻¹R^{T})eₖ (6)

is serially uncorrelated and

vₖ=R^{T}yₖ=Mvₖ+R^{T}eₖ (7)

contains the l dimensional latent dynamic series completely.
Proof. Using R^{T}P′=R^{T}PM⁻¹=I, we have R^{T}P=M. Since

(I−PM⁻¹R^{T})Pvₖ=(P−PM⁻¹R^{T}P)vₖ=(P−P)vₖ=0

Relation (6) is proven and, consequently, (I−PM⁻¹R^{T})yₖ is serially uncorrelated even though yₖ is serially correlated. It is noted that (I PM⁻¹R^{T}) is an oblique projection to R^{⊥} along P.

Relation (7) is obvious using (5) and R^{T}P′=I. Since the dynamic latent dimension of vₖ is l, no linear combinations of vₖ is serially uncorrelated. Therefore, for any non-singular M, the dynamic latent dimension of Mvₖ is l and (7) contains all l dimensional latent dynamics in vₖ.

Relation (7) indicates that vₖ can be modeled from vₖ up to a non-singular transformation matrix M. Therefore, with a suitable M, it is possible to make vₖ possess certain rank-order properties, even though the unknown latent source vₖ is not rank-ordered. For example, a descending order of predictability measured by canonical correlations can be implemented [19].

Since eₖ is serially independent, the dynamics of vₖ can be obtained by modeling vₖ. In this paper, we define a dynamic latent vector autoregressive (LaVAR) model as

$${R}^{T} {y}_{k} = {v}_{k} = {\sum }_{j = 1}^{s} {B}_{j} {v}_{k - 1} + {ε}_{k} \qquad ( 8 )$$

where the weights R and VAR parameters Bⱼ∈ [symbol] ^{l×l} for i=1, 2, . . . , s are to be estimated from data yₖ and εₖ∈ [symbol] ^{l} is serially independent noise.

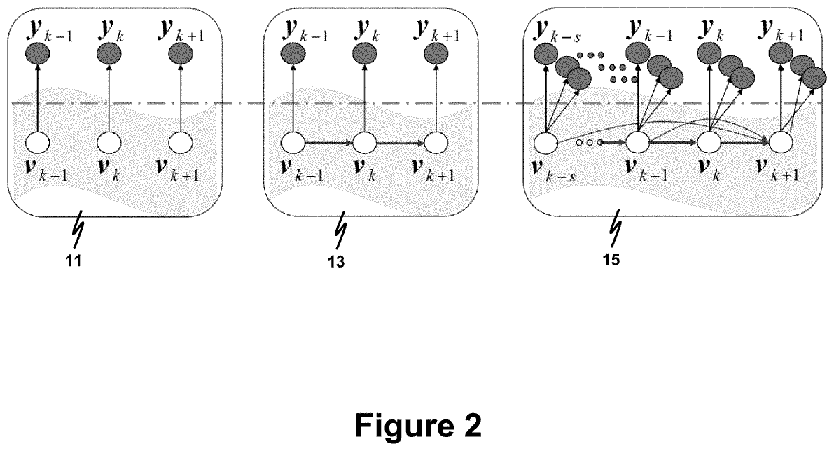

The LaVAR model performs dimension reduction and dynamic modeling simultaneously, which is different from PCA and hidden Markov models, as depicted in FIG. 2. In the PCA model 11, PCA performs dimension reduction so the latent variable dimension is smaller than the measured data dimension, but no serial correlation of the samples is built in the model. As a consequence, careless application of PCA to serially correlated data leads to erroneous inference. Hidden Markov models (HMM) 13 extract hidden state variables vₖ that carry first order dynamics. However, due to the restricted first order dynamics, the dimension of vₖ is often larger than that of yₖ. Hence, no dimension reduction is achieved. The LaVAR model 15 performs dimension reduction and dynamic latent VAR modeling simultaneously. Further, the AR dynamics of vₖ can be of any order to exhaust the serial correlation in the residuals.

In the present inventions method of dynamic latent variable modeling, we are interested in extracting dynamic latent variables vₖ which contain all latent variables that are predictable from their past values. This poses a challenge as both the unknown AR parameters Bᵢ and the weight matrix R in (8) have to be determined simultaneously. Once R is known and hence vₖ is known, the loading matrix P can be estimated from (1). In Y. Dong, S. J Qin, Dynamic latent variable analytics for process operations and control, Computers & Chemical Engineering 144 (2018 69-80 and in Dong, S. J Qin, A novel dynamic PCA algorithm for dynamic data modeling and process monitoring, Journal of Process Control 67 (2018) 1-11, the DLVs are extracted sequentially one after another by modeling each latent variable as a univariate AR model. It can be argued that the univariate latent variable models are restrictive in cases where the latent variables have significant interactive dynamics. The work in Y. Dong, S. J Qin, S. Boyd, Extracting a low-dimension predictable time series, Optimization and Engineering doi:https//doi.org/10.1007/s11081-021-09643-x extracts latent variables with interactive dynamics sequentially from one DLV to the next. When a new DLV is added to the model, however, the weight of the preceding DLVs are not updated. In the next section, we propose an iterative LaVAR algorithm that extracts multiple DLVs simultaneously with dynamic interactions.

Latent VAR Analysis and Algorithm—Latent VAR with a CCA Objective

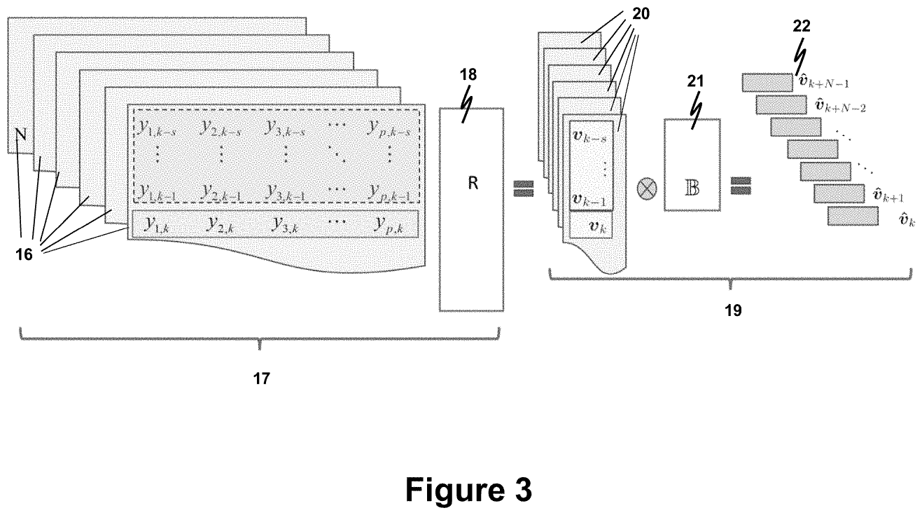

The objective of LaVAR analytics is to find a weight matrix R∈ [symbol] ^{p×l} and make the latent vector vₖ=R^{T}yₖ∈^{l} represent the dynamics of the data. From (8) it is clear that the LaVAR model first projects yₖ to a lower dimensional vₖ and then models vₖ with an VAR model based on its past values. This scheme is illustrated in FIG. 3. For each time instant the current measured data yₖ and a window of its past s at measured data matices 16 in DLV projection step 17 samples are projected to the current vₖ and its past s latent vectors at reduced dimensional latent scores matrices 20, which facilitates the predicted latent vector \hat{v}ₖ 22 We need N such instants of data to enable the estimation of the model parameters R 18 and B 21, which are shown in the figure as stacked matrices.

We form the stacked matrices of N samples as

Vᵢ=[vᵢ₊₁ vᵢ₊₂ . . . v_{i+N}]^{T}

Yᵢ=[yᵢ₊₁ yᵢ₊₂ . . . y_{i+N}]^{T}

Vᵢ=YᵢR i=0,1, . . . ,s (9)

For i=s, Vₛ=[vₛ₊₁vₛ₊₂ . . . v_{s+N}]^{T}. The LaVAR model (8) can be populated with data in the following matrix form,

YₛR=Vₛ₌Σⱼ₌₁^{s}Vs−jBTⱼ+Es=VB+Es (10)

where Eₛ is the LaVAR residual matrix and

[symbol]

=[Vₛ₋₁ Vₛ₋₂ . . . V₀]

=[B₁ B₂ . . . Bₛ] (11)

The objective function for the latent VAR model is naturally

$$\begin{matrix}{min}_{R , 𝔹} & J = {‖ {V}_{s} - 𝕍𝔹 ‖}_{F}^{2} \\ s . t . & {V}_{s}^{T} {V}_{s} = I\end{matrix} \qquad ( 13 )$$

where [symbol] . [symbol] _{F} denotes the Frobenius norm. The constraint V_{S}^{T}Vₛ=I ensures that the objective is equivalent to the sum of canonical correlations.

In the objective function (13), [symbol] and R are coupled bilinearly. If R is known, [symbol] can be estimated as a least squares solution. On the other hand, if [symbol] is given, it is possible to solve for R. Therefore, we propose to solve [symbol] and R iteratively via alternating optimization in this paper.

If R is given and, therefore, Vₛ and V are known, [symbol] can be found from objective function (13) as

[symbol]

=( [symbol] ^{T} [symbol] )⁻¹ [symbol] ^{T}Vₛ= [symbol] ⁺Vₛ (14)

where [symbol] ⁺ is the Moore-Penrose pseudo-inverse. The predicted Vₛ is

\hat{V}ₛ= [symbol] = [symbol] ⁺Vₛ (15)

The objective function (13) then become

$$\begin{matrix}{min}_{R} & {J}_{1} = {‖ {𝕍𝕍}^{+} {V}_{s} R ‖}_{F}^{2} = tr ( {{R}^{T} {Y}_{s}^{T}}^{s} {𝕍𝕍}^{+} {V}_{s} R ) \\ s . t . & {R}^{T} {Y}_{s}^{T} {Y}_{s} R = I\end{matrix} \qquad ( 17 )$$

because [symbol] ⁺=( [symbol] ⁺)² and ∥Vₛ∥_{F}²=tr(Vₛ^{T}Vₛ)=1. Therefore, the above objective function (16) is equivalent to

$$\begin{matrix}{min}_{R} & \begin{matrix}J = {‖ {V}_{s} - 𝕍𝔹 ‖}_{F}^{2} = {‖ {V}_{s} - {𝕍𝕍}^{+} {V}_{s} ‖}_{F}^{2} \\ = {‖ {V}_{s} ‖}_{F}^{2} - {‖ {𝕍𝕍}^{+} {V}_{s} ‖}_{F}^{2} = l - {‖ {𝕍𝕍}^{+} {V}_{s} ‖}_{F}^{2}\end{matrix} \\ s . t . & {V}_{s}^{T} {V}_{s} = 1\end{matrix} \qquad ( 16 )$$

The following theorem is given the relate to above objective to canonical correlations given V.

Theorem 2. With an initial R∈ [symbol] ^{p×l} to calculate [symbol] , the solution to (17) is the l leading canonical correlations between [symbol] and Yₛ. By performing the economic-form SVD as,

Yₛ= [symbol] ₛ [symbol] ₛ [symbol] ₛ^{T} (18)

where [symbol] ₛ contains the non-zero singular valves only, and eigen-decomposition on

[symbol]

ₛ^{T} [symbol] ⁺ [symbol] ₛ= [symbol] ₁Λ₁ [symbol] ^{T} (19)

where Λ₁ contains the eigenvalues in descending order, the optimal solution to (17) is R= [symbol] ₛ [symbol] ₛ⁻¹ [symbol] (:, 1:l), where [symbol] ₁(:, 1:l) the eigenvectors corresponding to the l largest eigenvalues.
Proof. By the method of induction, it was shown in L. Sun, S. J. Ye, Multi-Label Dimensionality Reduction, Chapman and Hall/CRC, 2013 that the objective (17) leads to the solution of l leading canonical correlations between Yₛ and V. From (18) we have

Vₛ=YₛR= [symbol] ₛ [symbol] ₛ [symbol] ₛ^{T}R=UₛW (20)

where W= [symbol] ₛ [symbol] ₛ^{T}R. The solution to R given W is

R= [symbol] ₛ [symbol] ₛ⁻¹W (21)

if rank(Yₛ)=p. If Yₛ has a reduced rank, [symbol] ₛ contains the non-zero singular values and (21) is the minimum norm solution.

We calculate

Vₛ₋ⱼ=Yₛ₋ⱼR for j=1,2, . . . ,s (22)

and form V according to (11). Using (20) we have

R^{T}Yₛ^{T}YₛR=W^{T} [symbol] ₛ^{T} [symbol] ₛW=W^{T}W

and the objective (17) becomes

$$\begin{matrix}{max}_{W} & {J}_{1} = {‖ {𝕍𝕍}^{+} {𝒰}_{s} W ‖}_{F}^{2} = tr ( {W}^{T} {𝒰}_{s}^{T} {𝕍𝕍}^{+} {𝒰}_{s} W ) \\ s . t . & {W}^{T} W = I\end{matrix} \qquad ( 23 )$$

The above objective is a standard eigen-problem and the optimal solution is W= [symbol] ₁(:, 1:l), that is, the eigenvectors corresponding to the l largest eigenvalues. The theorem is proved by using (21).

### LaVAR-CCA Algorithm and Geometric Properties

Theorem 2 gives an iterative algorithm that updates V with a new R until convergence. To map Vₛ back to Yₛ after convergence, (4) is used to minimize its residual as

$${min}_{P} {‖ {Y}_{s} - {V}_{s} {P}^{T} ‖}^{2} \qquad ( 24 )$$

which gives the loadings

P=Yₛ^{T}Vₛ(Vₛ^{T}Vₛ)⁻¹=Yₛ^{T}Vₛ

To initialize the algorithm W is chosen to be the first l columns of the identity matrix, which gives V to calculate (19). The complete algorithm is referred to as LaVAR-CCA and is summarized in Algorithm 1.

The LaVAR-CCA algorithm has attractive geometric properties. From the constraint Vₛ^{T}Vₛ=I, the DLV scores are guaranteed to be orthonormal. We also have

P^{T}R=Vₛ^{T}YₛR=Vₛ^{T}Vₛ=I,

which automatically achieves the condition given in Lemma 1. Furthermore, PR^{T} and (I−PR^{T}) are oblique projections to the ranges of P and R^{⊥}, respectively as has been shown in G. Li, S. J. Qin, D. Zhou, Geometric properties of partial least squares for process monitoring, Automatica 46 (2010) 204-210.

The use of the LaVAR-CCA algorithm in the system and method of the current invention avoids the sequential factor by factor calculations of the DiCCA algorithm and builds a fully interacting latent VAR model. The extracted DLVs also possess a descending order of predictability in terms of R² of the predicted latent scores. These properties are attractive for its use in visualization, interpretation, and feature analysis.

### Profit Likelihood Interpretation and Convergence

The LaVAR-CCA algorithm has a profile likelihood interpretation, which is a powerful statistical technique [26]. Assuming εₖ in the LaVAR model (8) is i.i.d. Gaussian, the log-likelihood function corresponding to (13) is:

$$L ( R , 𝔹 ) = - {\sum }_{k = s + 1}^{s + N} {‖ {v}_{k} - {\sum }_{j = 1}^{s} {B}_{j} {v}_{k - j} ‖}^{2} = - {‖ {V}_{s} - 𝕍𝔹 ‖}_{F}^{2}$$

Algorithm 1 The LaVAR-CCA Algorithm

| | |
|---|---|
| 1: | Scale data Y to zero mean and unit variance. Perform economic SVD and keep |
| | non-zero singular values only in |
| | Yₛ = [symbol] ₛ [symbol] ₛ [symbol] ₛ^{T} |
| 2: | Select l and initialize W = I(:, 1 : l), form [symbol] using (11) and calculate (19). |
| 3: | repeat |
| 4: | Set W = [symbol] ₁(:, 1 : l), calculate (22) and iterate |
| | [symbol] = [Vₛ₋₁ Vₛ₋₂ ... V₀] |
| | [symbol] ₛ^{T} [symbol] + [symbol] ₛ = [symbol] ₁Λ₁ [symbol] ₁^{T} |
| 5: | until convergence. |
| 6: | Calculate |
| | [symbol] = [symbol] ⁺Vₛ |
| | P = Yₛ^{T}Vₛ |
| | R = [symbol] ₛ [symbol] ₛ⁻¹W |

For fixed [symbol] , the profile likelihood function for R is:

$${L}_{p} ( R ) = {max}_{𝔹} L ( R , 𝔹 ) = - {‖ {V}_{s} - 𝕍 \hat{𝔹} ‖}_{F}^{2} = {‖ {𝕍𝕍}^{+} {Y}_{s} R ‖}_{F}^{2} - l$$

by making use of (16). Therefore, maximizing Lₚ(R) is equivalent to maximizing the objective (17). The objective, however, is not quadratic since V depends on R. Hence, the algorithm is necessarily iterative, that is,

$${R}^{i + 1} = arg {max}_{R} {‖ 𝕍 ( {R}^{i} ) {𝕍}^{+} ( {R}^{i} ) {Y}_{s} R ‖}_{F}^{2}$$

or equivalently, following (23):

$${W}^{i + 1} arg {max}_{W , {W}^{T} W = I} {J}_{1}^{i} ( W ) = {‖ 𝕍 ( {W}^{i} ) {𝕍}^{+} ( {W}^{i} ) {𝒰}_{s} W ‖}_{F}^{2} \qquad ( 25 )$$

Next it is shown that the iterations are expected to converge. Since (I V(Wⁱ)V⁺(Wⁱ)) is a projection matrix, which is positive semi-definite, we have:

W^{T} [symbol] ₛ^{T}(I− [symbol] (Wⁱ) [symbol] ⁺(Wⁱ)) [symbol] ₛW [symbol] 0

where [symbol] denotes a positive semi-defined relationship. Therefore:

W^{T} [symbol] ₛ^{T} [symbol] (Wⁱ) [symbol] ⁺(Wⁱ) [symbol] ₛW [symbol] W^{T} [symbol] ₛ^{T} [symbol] W=W^{T}W=Iₗ

for any W. The objective in (25) for the optimal Wⁱ⁺¹ becomes:

J₁ⁱ(Wⁱ⁺¹)=tr((Wⁱ⁺¹)^{T} [symbol] ₛ^{T} [symbol] (Wⁱ) [symbol] ⁺(Wⁱ) [symbol] ₛWⁱ⁺¹)≤tr(Iₗ)=l

that is, the sequence Jⁱ(Wⁱ⁺¹) is bounded from above. Further, since the sequence is maximized for each i successively, it is expected to be non-decreasing, which implies convergence.

Since the eigenvalues of the objective (23) are less than one for any W, the algorithm drives the l eigenvalues towards one with each iteration. To illustrate the process of maximizing the eigenvalues with each iteration, the Eastman process data, Y. Dong, S. J. Qin, Dynamic latent variable analytics for process operations and control, Computers & Chemical Engineering 114 (2018) 69-80, is used with p=18 process variables to extract l=11 DLVs.

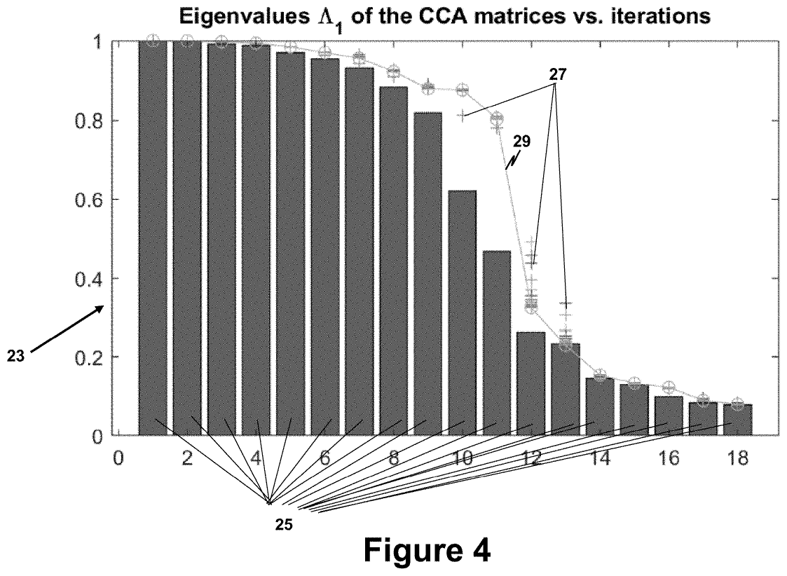

FIG. 4 depicts the results of maximizing the eigenvalues vs. the number of iterations 23. The bars 25 are the initial eigenvalues, the pluses 27 are intermediate results, while the curve 29 marked with circles represents the maximized eigenvalues after convergence. It took 33 iterations to converge. The iterations promote the leading 11 eigenvalues to be maximized. Since these eigenvalues correspond to the canonical correlations, the resulting model enables maximized prediction power for the 11 DLVs.

### LaVAR Model, System and Method Predictions

To make predictions based on the LaVAR model, system and method of the present invention we define the one-step ahead prediction performed by controller 106 as:

\hat{v}ₖ=E{vₖ|v₁,v₂, . . . ,vₖ₋₁}=E{vₖ|y₁,y₂, . . . ,yₖ₋₁}

Taking the conditional expectation of (8), we have:

$${\hat{v}}_{k} = {\sum }_{j = 1}^{s} {B}_{j} {v}_{k - j} = {\sum }_{j = 1}^{s} {B}_{j} {R}^{T} {y}_{k - j} \qquad ( 26 )$$

Further, taking the conditional expectation of (4), we have:

$${\hat{y}}_{k} = P {\hat{v}}_{k} = {\sum }_{j = 1}^{s} {PB}_{j} {R}^{T} {y}_{k - j} \qquad ( 27 )$$

which can be regarded as a VAR model with reduced rank coefficient matrices PBⱼR^{T}. Equation (27) gives the prediction of the current data using dynamic latent variables. The one-step ahead prediction error is:

êₖ=yₖ−ŷₖ=yₖ−P\hat{v}ₖ (28)

### Case Study on a Lorenz Oscillation System

The Lorenz oscillator, E. Lorenz, Deterministic non-periodic flow, J. Atmos. Science 20 (2) (1963) 130-141, is a nonlinear chaotic system that is governed by three ordinary differential equations:

\dot{x}=−σx+σy

\dot{y}=rx−y−xz

Ż=−bz+xy

which is a simplified model for atmospheric convection, where x is related to the rate of convection, y to the horizontal temperature variation, and z to the vertical temperature variation.

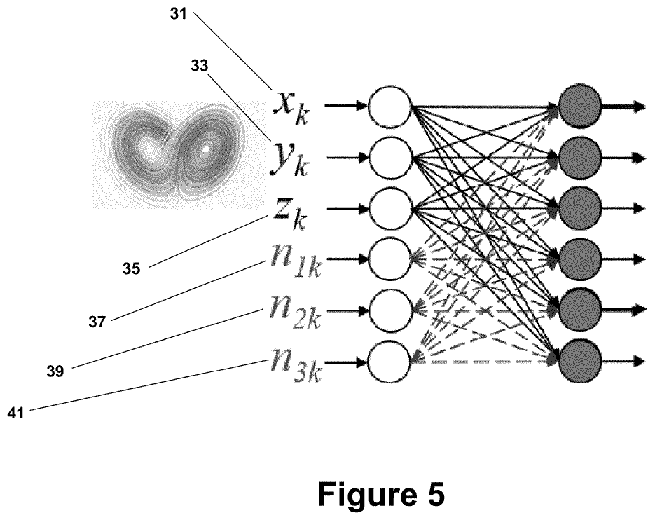

The Lorenz oscillator is highly time dependent. In the model, method and system of the present invention we assume the three coordinates in [x, y, z]^{T} are measured by six very noisy sensors. Each sensor measures a fraction of the three variables with 100% corrupted noise from three independent sources, as shown in FIG. 5 and described below.

Let [xₖ, yₖ, zₖ, n₁ₖ, n₂ₖ, n₃ₖ]^{T} (with reference to FIG. 5 xₖ 31, yₖ 33, zₖ 35, n₁ₖ 37, n₂ₖ 39, n₃ₖ 41) be the signal and noise sources that are mixed by the following matrix. The data is generated with:

$${y}_{k} = [ \begin{matrix}- 0.4944 & 0.2348 & - 0.0113 & 0.1516 & - 0.8163 & - 0.1052 \\ 0.4027 & 0.2678 & 0.3116 & 0.6135 & - 0.1251 & 0.5263 \\ - 0.1851 & - 0.1921 & - 0.3998 & - 0.3104 & - 0.1002 & 0.8141 \\ - 0.0997 & - 0.7551 & - 0.24 & 0.5933 & - 0.0309 & - 0.0963 \\ - 0.6501 & 0.36 & - 0.0977 & 0.3531 & 0.5524 & 0.0918 \\ - 0.3558 & - 0.3694 & 0.8221 & - 0.1662 & 0.0441 & 0.1777\end{matrix} ] [ \begin{matrix}{x}_{k} \\ {y}_{k} \\ {z}_{k} \\ {n}_{1 k} \\ {n}_{2 k} \\ {n}_{3 k}\end{matrix} ]$$

where the noise sources [n₁, n₂, n₃]^{T} have the same energy or variance as the signals in [n₁, n₂, n₃]^{T}. The mixed sequence {yₖ} is the noisy data to be analyzed via the proposed LaVAR-CCA method. For comparison, PCA is applied in parallel, which obtains leading components with maximized variances.

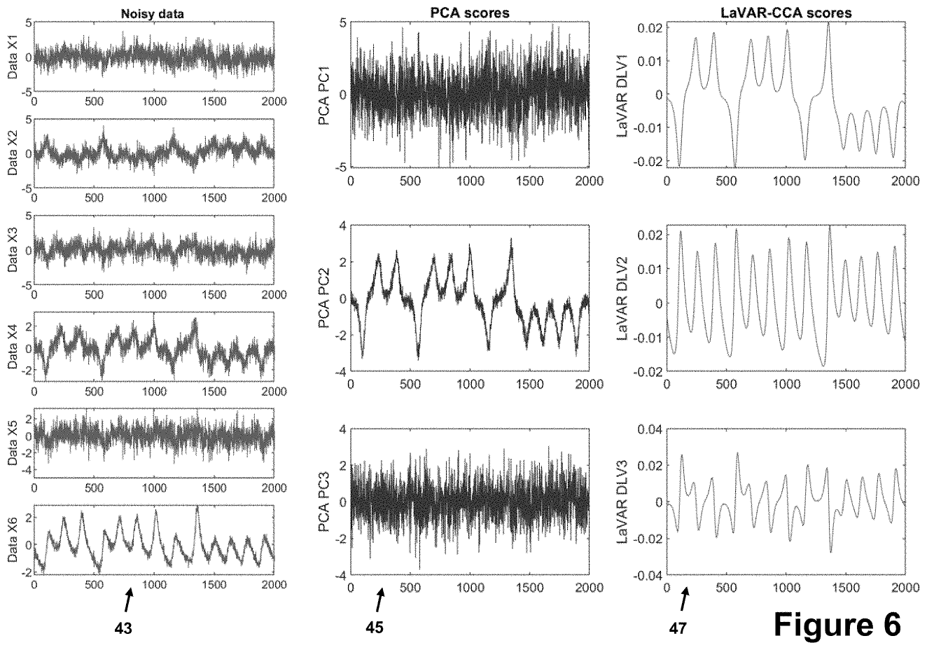

FIG. 6 shows the noisy data 43 with six sensors, the leading three PCA scores 45, and the leading three LaVAR scores 47. It is clear that LaVAR-CCA extracts three DLVs that remove noise nearly completely. PCA, which pays attention to largest variance only, extracted the first PC that is mostly noise. The second PC resembles the first LaVAR DLV, but is much more noisy. The third PC is again mostly noise.

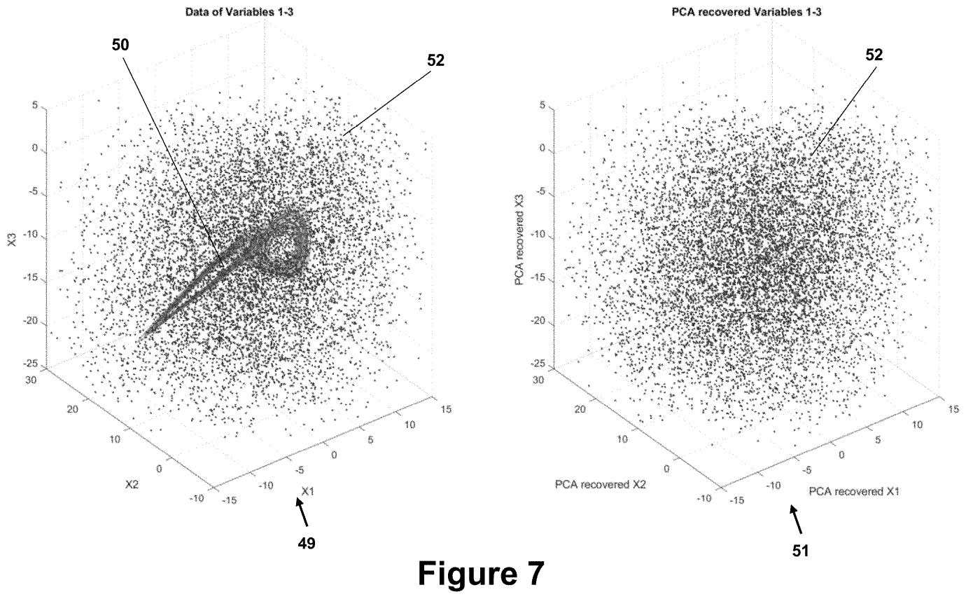

Mapping, using controller 106, the latent scores to the original data space can show how each method reconstructs the signals from the latent variables. FIG. 7 depicts 3D plots for the first three variables of the noisy data 49 and PCA reconstructed data 51 using the three leading PCs. The line curves 50 show the true signals of the three variables, but only the dot noisy data 52 are available. It is obvious that PCA fails to recover the true signals from the highly noisy data.

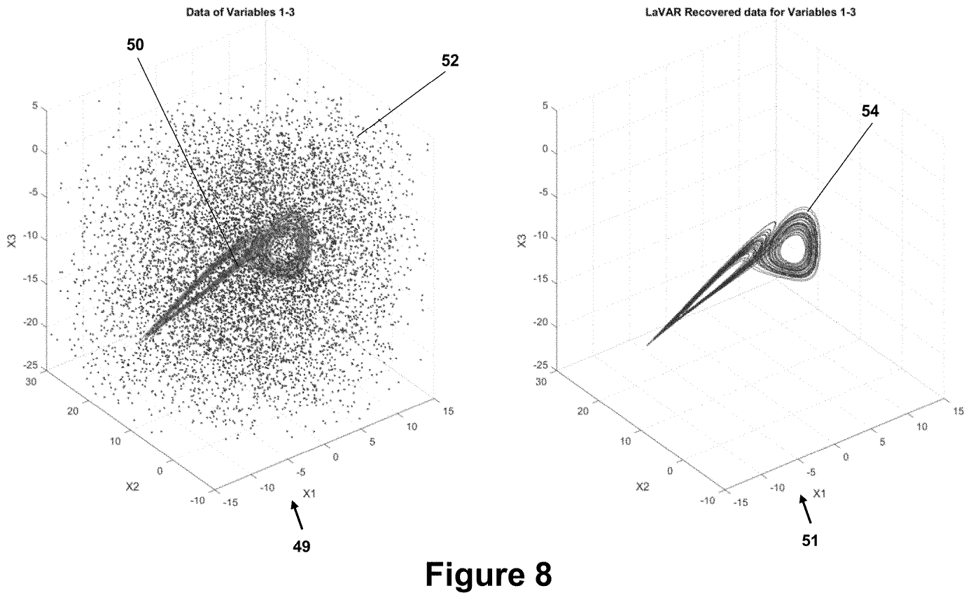

On the other hand, FIG. 8 depicts the 3D plots of the first three variables of the noisy data 49 and LaVAR-CCA reconstructed data 53 with three latent variables. The curves 54 on the right panel show the LaVAR-CCA reconstructed signals from the highly noisy data. It is clear that the LaVAR-CCA model recovers precisely the true signals from the highly noisy data.

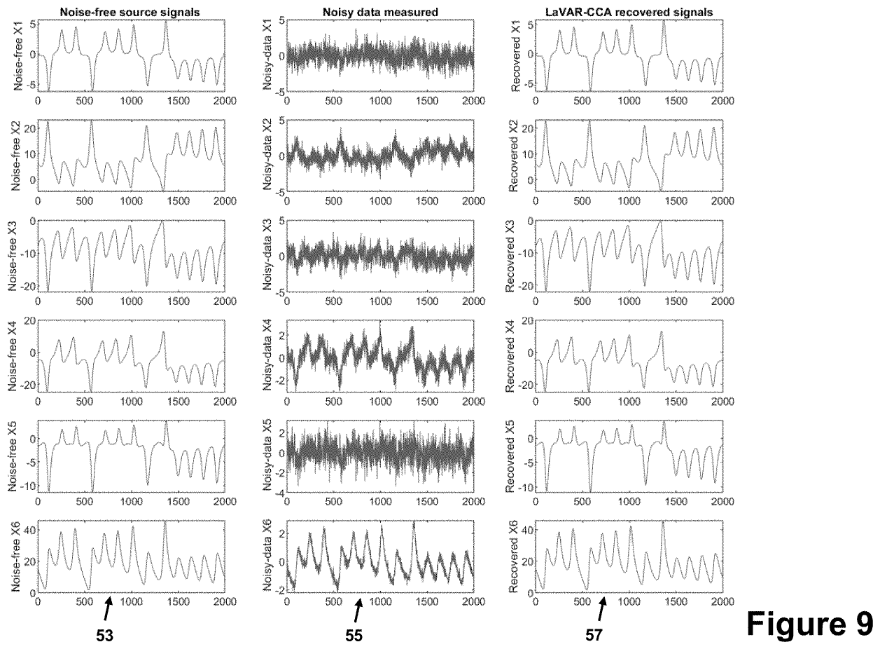

To visualize all six variables, FIG. 9 depicts the true signals 53, which are not available but contained in the noisy data 55, and LaVAR-CCA reconstructed variables of the latent Lorenz system 57. The figure shows convincingly that LaVAR-CCA, which maximizes the predictability of the extracted DLVs, reconstructs the signals clearly from the highly noisy data.

### Application to Data of an Industrial Chemical Process

A real industrial dataset from the Eastman Chemical Company, N. Thornhill, J. Cox, M. Paulonis, Diagnosis of plant-wide oscillation through data-driven analysis and process understanding, Control Engineering Practice 11 (2003) 1481-1490, provides a good test case for process oscillation analysis and troubleshooting. The dataset contains 60 variables with numerous process control loops and 8640 samples with a sampling interval of 20 seconds. The data span 48 hours in time. Plant-wide oscillations are evident in this dataset with a period of about 2 hours.

An oscillating latent signal is most easily predictable by its own past. In the present invention we demonstrate and compare the proposed LaVAR-CCA algorithm with DiCCA using the dataset. As in the experimental setup in Y. Dong, S. J. Qin, Dynamic-inner canonical correlation and causality analysis for high dimensional time series data, IFAC-PapersOnLine 51(18) (2018) 476-481, 18 variables with strong oscillation patterns of two-hour periods are selected for this study, which are LC1.PV, LC1.OP, FC1.SP, FC1.PV, FC2.SP, FC2.PV, TI4.PV, TC1.PV, TC1.OP, FCS.OP, FCS.PV, LC2.PV, LC2.OP, FC8.SP, FC8.PV, TC2.OP, TI8.PV, and FI3.PV. For the ease of visualization of dynamic latent features, 1000 data samples are used, which cover around 333 minutes. In Y. Dong, S. J. Qin, Dynamic-inner canonical correlation and causality analysis for high dimensional time series data, IFAC-PapersOnLine 51(18) (2018) 476-481, the DiCCA autoregressive order s was selected as 28 to make the latent residuals uncorrelated, while only 13 out of 18 latent factors have R² values above 0.5. Since DiCCA builds non-interacting latent AR models only, these models usually need to be high order to exhaust the serial correlation. In the present invention, we choose the autoregressive order as 10 and the number of latent variables as 13 to compare the efficacy of LaVAR-CCA models with DiCCA models.

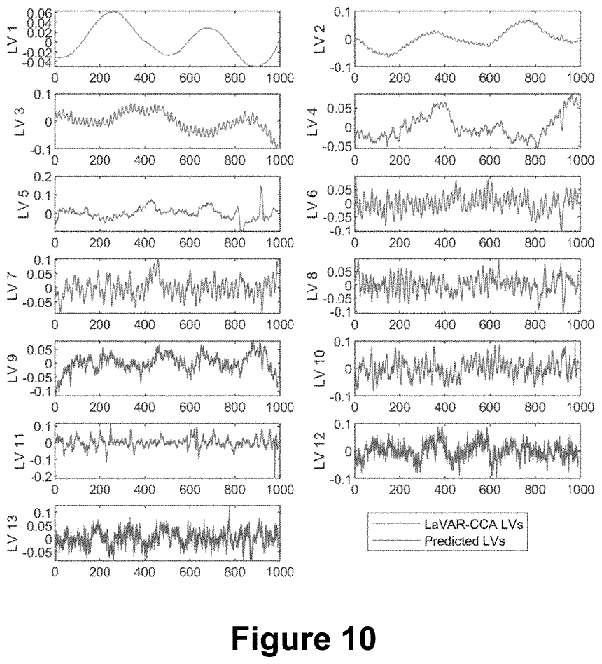

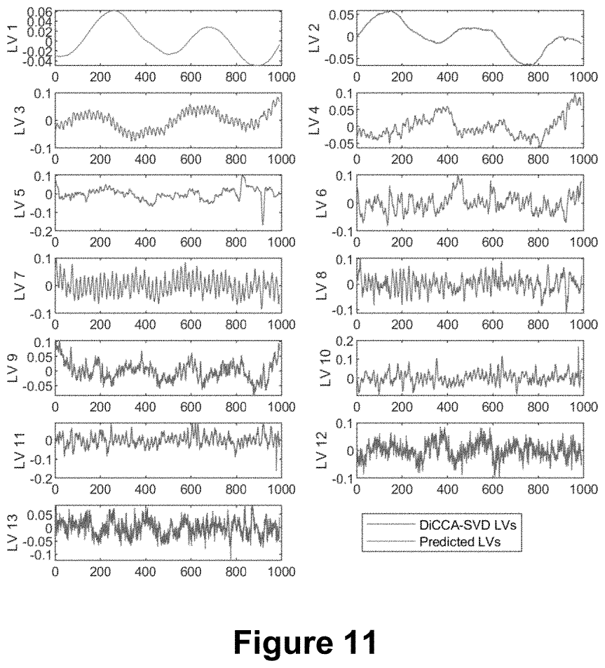

First of all, the 13 LaVAR-CCA DLV scores along with their predicted values are shown in FIG. 10, while the corresponding DiCCA results are shown in FIG. 11 using the DiCCA-SVD algorithm in [2]. It is easy to observe that the leading DLVs are highly predictable since the predictions are nearly on top of the extracted DLV scores. The last few DLVs show observable differences between the extracted and predicted DLV scores.

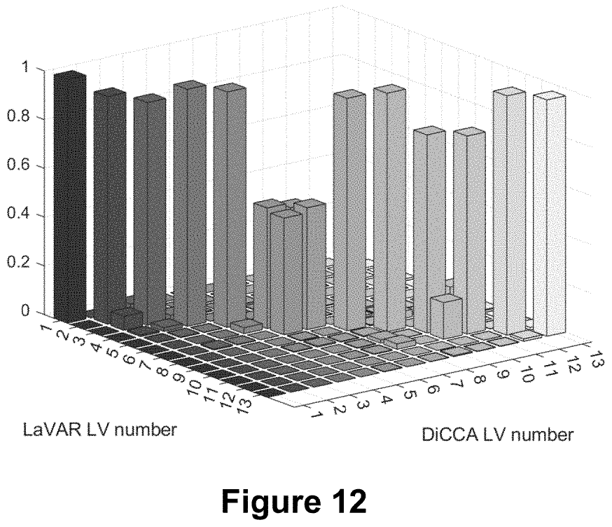

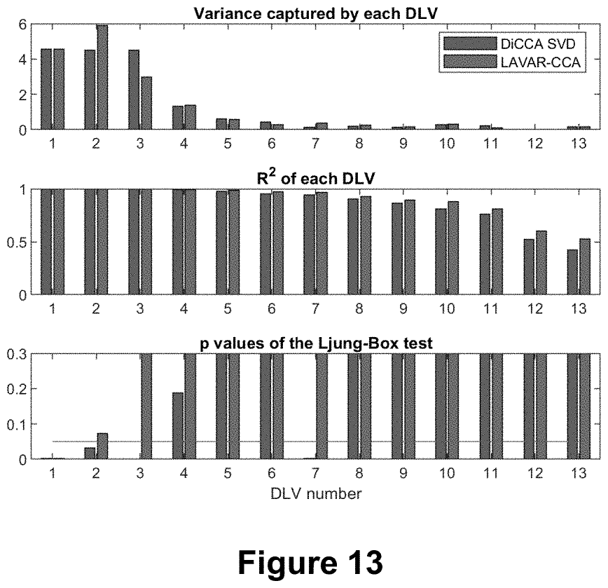

Secondly, the leading five DLVs from both models are similar, while the remaining DLVs show differences. To compare the extracted DLV scores from both models, we calculate the squared correlations and show them in FIG. 13. Note that two latent variables with opposite signs are the same since latent variables are sign-invariant. It is clearly observed from FIG. 12 that:
1. All DLVs other than DLVs 6, 7, 10 and 11 from both models are highly similar pair-wisely.
2. DLVs 6 and 7 of both models are nearly equally correlated, but they are not correlated to other DLVs of either models. This evidence indicates that DLVs 6 and 7 of the respective models are different, but they represent a distinct two-dimensional latent subspace. A close examination of them in FIGS. 109 and 11 reveals that they contain a high frequency oscillation of the same frequency, which is pertinent to another oscillation feature detected in [19].
3. DLVs 10 and 11 of the respective models have high pairwise correlations, while each has a small fraction of correlation with the other DLV of the other model. This evidence indicates that DLVs 10 and 11 are pair-wisely similar, but with an appreciable difference.
4. DLVs 2 and 3 of the respective models have high pairwise correlations with each other, while each has a tiny fraction of correlation with the other DLV of the other model. This subtle difference can be seen from DLV 2 in both FIGS. 10 and 10.

Next, we compare the efficiency in extracting and predicting dynamics in the latent variables. In latent dynamic modeling we look for i) highly predictable dynamic latent variables and ii) modeling the latent dynamics effectively to obtain serially uncorrelated residuals. To measure the latent predictability we use the R² values, while the whiteness of residuals are measured with the well-known Ljung-Box Q test [32].

FIG. 13 compares the variances captured, R² values, and Ljung-Box Q test values between the LaVAR-CCA and DiCCA DLV scores. It is evident from the top panel of the figure that the LaVAR-CCA captures more variance in DLV 2 than DiCCA does, thus leaving less variance for its DLV 3. The variances beyond DLV 4 are very small, but they can contain important features. For example, the DiCCA's DLV 7 in FIG. 10 contains another oscillation at a higher frequency.

The R² values of the LaVAR-CCA DLVs in the middle panel of FIG. 13 are generally higher than those of DiCCA, making the LaVAR-CCA algorithm more efficient in predicting the latent variables. This is not surprising since the LaVAR DLV model is fully-interacting.

Lastly, the Ljung-Box Q test for whiteness of the residuals is shown in the bottom panel of FIG. 12, where the p-values and a 0.05 confidence line are shown for easy inference. The Ljung-Box test results indicate that the DiCCA model with s=10 leaves DLVs 1, 2, 3, and 7 non-white, while the LaVAR-CCA model with s=10 makes DLVs 2, 3, and 7 white. Note that this experiment is not about optimizing the model order selection, but to reveal the differences between the two modeling algorithms.

The LaVAR-CCA algorithm is developed and demonstrated in this paper to have successfully built interacting, latent VAR models. While DiCCA uses non-interacting, univariate latent AR models, LaVAR-CCA uses a fully interacting latent VAR model for a selected number of DLVs. The LaVAR-CCA DLVs scores are enforced to be orthogonal. In other words, the dynamic latent variables are contemporaneously independent. This is important to make each of the latent features unique. The synthetic data analysis from a simulated Lorenz system shows that the proposed LaVAR-CCA algorithm is effective to filter out high variance noise from serially dependent signals, but PCA that focuses on variance maximization fails to do so. Application to an industrial dataset shows that the proposed LaVAR-CCA algorithm is superior to DiCCA, although the two models share many similar latent features in this example.

The LaVAR model structure improves the reduced dimensional latent dynamic modeling with general latent VAR dynamics. The LaVAR-CCA algorithm optimize all model parameters simultaneously. This algorithm advances the algorithm in [22], where the model is built sequentially DLV by DLV, but preceding weight matrices are not optimized in subsequent steps.

It should be noted that among the aforementioned algorithms, the latent variable scores are guaranteed to be orthogonal or uncorrelated instantaneously. While interactions among the latent variables at different time instants exist in general, it is arguable that the instantaneously orthogonal latent scores are able to reduce the coupling of latent variables at different time instants.

This is observed in the analysis of the real industrial plant data. We further observed in numerous cases that the non-interacting DLV models extract essentially the same DLVs as the LaVAR-CCA model does, especially when the data contain highly predictable latent factors. The analysis in [11] shows that fully interacting DLV systems can have marginal univariate latent models at the expense of increased prediction errors and increased orders of the latent models.

Another note on the interacting LaVAR model is that all of the LaVAR model parameters change if the number of DLVs changes. This is not a disadvantage since most multivariate models such as the conventional VAR models and state space models estimated via subspace identification share this characteristic. On the other hand, for non-interacting DiCCA models, the preceding latent model parameters remain unchanged when subsequent DLVs are added to the model.

What is claimed is:

1. A method for extracting latent vector autoregressive (LaVAR) models with full interactions amongst mutually independent dynamic latent variables (DLV) from multi-dimensional time series data comprising:
detecting, by a plurality of sensors, dynamic samples of data corresponding to a plurality of original variables;
analyzing, using a controller, the dynamic samples of data to determine a plurality of latent variables that represent variation in the dynamic samples of data;
estimating an estimated current value for all of the latent variables, wherein the estimation for all of the latent values is conducted simultaneously through an iterative process; and
wherein each of the latent variables are contemporaneously uncorrelated.

2. The method of claim 1, wherein each latent variable is modelled as a univariate autoregressive model.

3. The method of claim 1, wherein the dynamic samples of data are represented in a ranked, stacked matrices.

4. The method of claim 3, wherein analyzing the dynamic samples of data includes attaching a weighting to the ranked, stacked matrices.

5. The method of claim 4, wherein autoregression is applied to a latent vector of the dynamic samples of data.

6. The method of claim 5, wherein the latent vector is represented in ranked, stacked matrices.

7. The method of claim 6, wherein a vector weighting is applied to the latent vector matrices.

8. The method of claim 6, wherein the weighting of the dynamic samples of data and the vector weighting are coupled.

9. The method of claim 8, wherein the latent vector is iteratively treated with an updated weighting.

10. The method of claim 9, wherein the treated latent vectors converge.

11. The method of claim 1, wherein the model's DLVs are orthonormal to each other.

12. A system for extracting latent vector autoregressive (LaVAR) models with full interactions amongst mutually independent dynamic latent variables (DLV) from multi-dimensional time series data comprising:
a plurality of sensors, configured to detect dynamic samples of data corresponding to a plurality of original variables;
an output device configured to output data; and
a controller coupled to the plurality of sensors, the controller configured to:
analyze the dynamic samples of data to determine a plurality of latent variables that represent variation in the dynamic samples of data;
estimate an estimated current value for all of the latent variables, wherein the estimation for all of the latent values is conducted simultaneously through an iterative process; and
wherein each of the latent variables are contemporaneously uncorrelated.

13. The system of claim 12, wherein the controller models each latent variable as a univariate autoregressive model.

14. The system of claim 12, wherein the controller represents dynamic samples of data in a ranked, stacked matrices.

15. The system of claim 12, wherein the controller applies autoregression to a latent vector of the dynamic samples of data.

16. The system of claim 15, wherein controller represents the latent vector in ranked, stacked matrices.

17. The system of claim 16, wherein controller applies a vector weighting to the latent vector matrices.

18. The system of claim 16, wherein the controller couples the weighting of the dynamic samples of data and the vector weighting.

19. The system of claim 18, wherein the controller iteratively treats the latent vector with an updated weighting.

20. The system of claim 12, wherein the controller models the DLVs to be orthonormal to each other.

21. The system of claim 12, wherein the controller filters out high variance noise from serially dependent signals.
